(19) United States
(12) Patent Application Publication
(10) Pub. No.: US 2009/0138223 A1
(43) Pub. Date: May 28, 2009

(54) On-Line Quality Prediction System for Stainless Steel Slab and the Predicting Method Using It

(76) Inventors: Jong-Wan Kim, Kyungsangbuk-do (KR); Ja-Yong Choi, Kyungsangbuk-do (KR); Bo-Sung Seo, Kyungsangbuk-do (KR)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/992,736

(22) PCT Filed: Sep. 27, 2006
(86) PCT No.: PCT/KR2006/003842

§ 371 Date: Mar. 28, 2008

(30) Foreign Application Priority Data
Oct. 4, 2005 (KR) 10-2005-0092778

(51) Int. Cl. G06F 19/00

(52) U.S. Cl. 702/81

(57) ABSTRACT

Disclosed is an on-line quality prediction system for stainless steel slab and the predicting method using it, which can allow produced slab quality to predict in high precision on the on-line using a network based system by collecting all operation data available from a steel making process to a continuous casting process and then using them as a metallurgical calculation evaluating model through thermodynamics and statistics programs, the system comprises: a main computer collecting and storing information from a production line for the stainless steel slab; a thermodynamics calculation only computer mutually communicating with the main computer; and a server computer mutually communicating with the main computer, whereby it can overcome a limitation of a predicting method due to existing operation data and allow produced slab quality to predict in high precision on the on-line using a network based system by collecting all operation data available from a steel making process to a continuous casting process and then using them as a metallurgical calculation evaluating model through thermodynamics and statistics programs, significantly improving quality and productivity.

### BACKGROUND ART

1. Field of the Invention

The present invention relates to an on-line quality prediction system for stainless steel slab and the predicting method using it, and more specifically, an on-line quality prediction system for stainless steel slab and the predicting method using it, which can allow produced slab quality to predict in high precision on the on-line using a network based system by collecting all operation data available from a steel making process to a continuous casting process and then using them as a metallurgical calculation evaluating model through thermodynamics and statistics programs.

2. Description of Related Art

In general, stainless steel is produced via a steel making process and a continuous casting process.

FIG. 1 is a view graphically showing general stainless steel making process-a continuous casting process.

First, scrap iron is melted in an electric furnace to make hot metal. However, since the hot metal is obtained only by melting scrap iron, it contains a large amount of impurities.

Accordingly, the hot metal obtained via the electric furnace is made as molten steel configured of compositions usable as a product after being subjected to a decarburization process and a desulphurization process in a refining furnace.

After controlling final components and assuring temperature suitable for a continuous casting in ladle refining later, the molten steel is moved to a continuous caster.

The molten steel in the continuous caster is poured into a copperplate mold, which is cooled by water, via a tundish from the ladle and then is solidified so that it is produced into a slab, which is an intermediate product.

Such produced slab becomes a final product for using via a rolling process.

However, such produced slab would have several kinds of defects. As representative defects among these, there are crack that a slab surface is cracked, incorporation of nonmetal inclusions, formation of abnormal solidification structure, defect of surface oscillation mark, etc.

Since large defect exposed on a surface among the defects as above can be identified with the naked eye, it can be removed by a slab grinding, etc. However, since fine surface defect cannot be identified with the naked eye and defect inside the slab cannot be identified at all, the slab is grinded 100% or otherwise, a defective product must be accepted.

Further, the method needs the increased quality cost and causes a process load and the defective products due to the grinding, thereby degrading productivity.

As a result, in order to overcome the problems, it has developed techniques to allow the operators to precisely predict quality state for slab on an on-line without inspecting the slab.

Typically, since cost removing defects is increased as the process is progressed, in other words, since predicting defects in slab state and removing them is more economical in cost and process efficiency, if the slab on which the grinding need to be performed or not to be performed is sorted by using prediction results of a quality prediction system with high precision, it is unnecessary to perform the 100% grinding on the slab required not to be grinded so that the economical profit can be expected as well as product quality is assured by performing the grinding only on the slab required to be grinded so that productivity can be expected.

In order to achieve the purpose, it has been developed a quality prediction system for slab, such as VAI-Q available from Voes Corporation; M-Cast available from Terni Corporation; and MIDAS available from Preussag S. Corporation, etc.

VAI-Q available from Voest Corporation is a system, which judges whether product is right or wrong depending on quality evaluation result by using operation data in a steel making process and a continuous casting process.

M-Cast available from Terni Corporation is a system, which predicts stainless steel slab quality in real time by using copperplate temperature and continuous casting operation data.

MIDAT available from Preussag S. Corporation is a system, which transfers evaluation data using production planning, quality and process data, etc to a production planning department and then changes them prior to cutting the slab.

However, since the features of the systems adopt a simply evaluation method for the operation data so that slab quality is evaluated by only the difference between a target value and an actual value, only the precision of the operating is evaluated so that it is impossible to precisely predict various slabs quality.

For example, in terms of the casting velocity, there is a case that it has decisive effect on some items but an insignificant effect on other items. The conventional system has that various weighting values depending on important degree are disregarded.

Also, since most of the conventional quality predicting methods for slab have been developed for a general carbon steel, they has a limitation to directly apply to stainless steel. The reason is that the stainless steel and the general carbon steel very differ in terms of their quality. For example, since the stainless steel has a very small amount of scale removed in a heating furnace, in the general carbon steel all the ultra surface defects on the slab in which scale is removed is expanded as product defects.

As a result, unlike the general carbon steel, in the quality predicting method for the stainless steel slab, there has been required a system considering carburizing and sulphurizing defects, etc., on the ultra surface of the slab including oscillation mark and an advanced sensor measuring system using a laser sensor, etc., and a statistics and thermodynamics calculation program capable of yielding more precise evaluation results, and a network based system capable of being used more easily by the operators.

### SUMMARY OF THE INVENTION

Accordingly, the present invention is proposed to solve the problems in a prior art as described above. It is an object of the present invention to provide an on-line quality prediction system for stainless steel slab and the predicting method using it, which can overcome a limitation of a predicting method due to existing operation data and allow produced slab quality to predict in high precision on the on-line using a network based system by collecting all operation data available from a steel making process to a continuous casting process and then using them as a metallurgical calculation evaluating model through thermodynamics and statistics programs, significantly improving quality and productivity.

### ADVANTAGEOUS EFFECTS

An on-line quality prediction system for stainless steel slab according to the present invention and the predicting method using it as described above can overcome a limitation of a predicting method due to existing operation data and allow produced slab quality to predict in high precision on the on-line using a network based system by collecting all operation data available from a steel making process to a continuous casting process and then using them as a metallurgical calculation evaluating model through thermodynamics and statistics programs, significantly improving quality and productivity.

### BRIEF DESCRIPTION OF THE DRAWINGS

FIG. 1 is a view graphically showing general a stainless steel making process-a continuous casting process;

FIG. 2 is a view showing an on-line quality prediction system for stainless steel slab according to a preferred embodiment of the present invention;

FIG. 3 is a conceptual view of FIG. 2;

FIG. 4a is a view showing the insertion of a thermocouple into a mold for measuring initial solidification uniformity according to FIG. 2;

FIG. 4b is a view showing position of a thermocouple installed on a copperplate;

FIG. 5a is a view schematically showing a laser sensor for calculating deposit depth of a submerged nozzle among principles evaluating continuous casting operation stability;

FIG. 5b is a view showing ascending flow velocity for molten steel flux evaluation based on continuous casting operating stability evaluation principle according to FIG. 5a;

FIG. 6 is a graph showing an effect utilizing mold heat transfer evaluation item of a predicting method using an on-line quality prediction system for stainless steel slab according to a preferred embodiment of the present invention;

FIG. 7a is a graph showing distribution of delta ferrite in 304 steel slab;

FIG. 7b is a photograph of macro solidification structure showing 430 steel slab solidification structure;

FIG. 7c is a photograph of macro solidification structure showing 420 steel slab solidification structure;

FIG. 8a is a view sorting oscillation mark quality;

FIG. 8b is a graph showing carbon and sulfur picked up from mold powder on a slab surface including oscillation mark;

FIG. 9a is a graph showing the difference between a prediction value and an actual value of oscillation mark;

FIG. 9b is a graph showing the difference between a prediction value and an actual value of carbon pick-up amount;

FIG. 10a is a view graphically showing concept of oxide evaluation according to an embodiment of the present invention;

FIG. 10b is a view graphically showing concept of nitride and bubble evaluation according to an embodiment of the present invention;

FIG. 11a is a view graphically showing an internal inclusions forming device;

FIG. 11b is a view graphically showing a method of calculating composition, oxide amount, crystalline phase, overall oxygen of internal inclusions based on the forming device shown in FIG. 11a;

FIG. 12a is a view showing mutual comparison between a prediction value of overall oxygen with an actual value of overall oxygen;

FIG. 12b is a graph showing prediction value of the amount of high melting point inclusion among inclusions in steel; and

FIG. 13 is a graph showing an effect utilizing deposit depth evaluating item of a submerged nozzle of a predicting method using an on-line quality prediction system for stainless steel slab according to a preferred embodiment of the present invention;

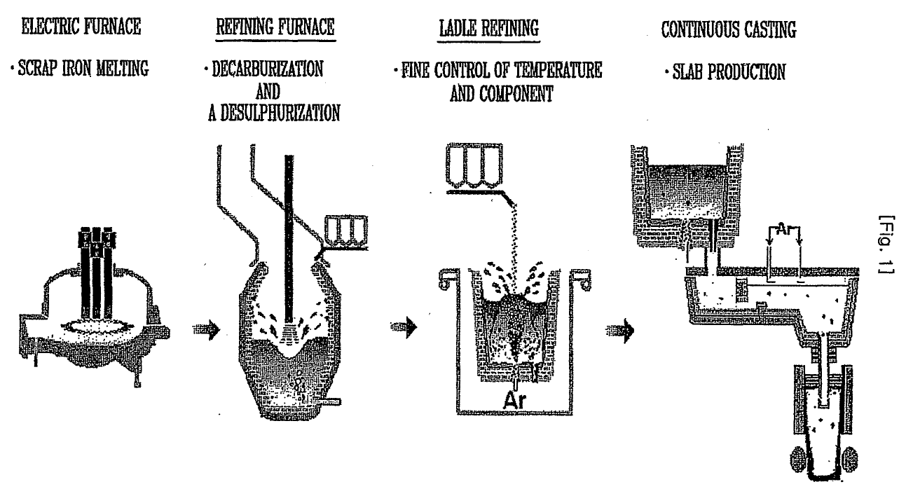

### DETAILED DESCRIPTION OF THE PREFERRED EMBODIMENTS

In order to accomplish the object, there is provided an on-line quality prediction system for stainless steel slab, comprising: a main computer collecting and storing information from a production line for the stainless steel slab; a thermodynamics calculation only computer mutually communicating with the main computer; and a server computer mutually communicating with the main computer.

Here, the information collected in the main computer is transferred to the thermodynamics calculation only computer and then stored in a database. The main computer is configured to perform at least one of data processing, metallurgical model calculation, and database management, and the thermodynamics calculation only computer is configured to perform at least one of thermodynamics calculations on purity and solidification.

Also, it further comprises a plurality of thermocouples, which are connected to the main computer to provide temperature information for initial solidification uniformity thereto. The plurality of thermocouples are installed in such a manner that they are inserted into copperplates, wherein five of the plurality of thermocouples is installed on the long side of the copperplates, respectively and one on the short sides thereof, respectively.

Preferably, the thermocouple is a sheath type thermocouple.

Also, it is preferable that six thermocouples on the inner side and right of the copperplate are connected to one socket and six thermocouples on the outside and left of the copperplate are connected to the other socket. As a result, the two sockets are extended out a mold so that the thermocouples are connected to the main computer.

Also, it further comprises a laser distance sensor connected to the main computer to provide information on deposit depth of a submerged nozzle thereto.

There is provided a predicting method using an on-line quality prediction system for stainless steel slab, comprising the steps of: measuring prediction items for predicting the stainless steel slab quality; evaluating for making numerical evaluation based on the measured prediction items; and predicting the stainless steel slab quality by analyzing the numerical yielded in the evaluating step.

Here, the prediction items are initial solidification uniformity, mold cooling velocity, slab solidification structure, slab oscillation mark quality, purity and continuous casting operation stability.

At this time, the information measured in the initial solidification uniformity is numerically evaluated in the evaluating step as copperplate temperature, copperplate temperature deviation, temperature ratio of the inside/outside of copperplate, temperature ratio of the left/right of copperplate, and temperature ratio of the long side/short side of copperplate.

The copperplate temperature is obtained by calculating average copperplate temperature by slab unit and evaluating the difference between it and optimal copperplate temperature by steel. The copperplate temperature deviation is obtained by evaluating the initial solidification stability by evaluating deviation degree through statistically analyzing all the copperplate temperature deviations by slab unit. The temperature ratio of the inside/outside of the copperplate is obtained by evaluating the initial solidification balance by calculating the temperature ratio of the inside and outside of the copperplate of the long side by slab unit and evaluating the difference between it and balance value. The temperature ratio of the left/right of the copperplate is obtained by evaluating the initial solidification balance degree by calculating the temperature ratio of the left/right of the copperplate of the short side by slab unit and evaluating the difference between it and balance value. The temperature ratio of the long and short sides of the copperplate is obtained by evaluating the initial solidification balance degree by calculating the temperature ratio of the copperplate of the long and short sides by slab unit and evaluating the difference between it and balance value.

Further, the information measured in the mold cooling velocity is numerically evaluated in the evaluating step as heat transfer amount, heat transfer amount deviation, heat transfer amount ratio of the inside/outside, heat transfer amount ratio of the left/right, and heat transfer amount ratio of the long/short sides.

Here, the heat transfer amount is obtained by calculating average heat transfer amount by slab unit evaluating the difference between it and optimal heat transfer amount by steel. The heat transfer amount deviation is obtained by evaluating deviation degree through the statistical analysis of all the heat transfer amount deviations by slab unit. The heat transfer amount ratio of the inside/outside is obtained by evaluating the balance degree of the heat transfer amount by calculating the heat transfer amount ratio of the inside and outside of the copperplate of the long side by slab unit and evaluating the difference between it and its balance value. The heat transfer amount ratio of the left/right is obtained by evaluating the balance degree of the heat transfer amount by calculating the left and right ratio of the copperplate of the short side by slab unit and evaluating the difference between it and balance value. The heat transfer amount ratio of long/short sides is obtained by evaluating the balance degree of the heat transfer amount by calculating the temperature ratio of the copperplate of the long and short sides by slab unit and evaluating the difference between it and balance value.

Further, the information measured in the slab solidification structure is numerically evaluated in the evaluating step as austenitic average residual ferrite, austenitic surface ferrite, ferritic equiaxed crystal ratio, and martensitic center segregation degree.

Here, the austenitic average residual ferrite is evaluated and obtained by using the following equation, that is, KRUPP equation.

$$δ \text{-} ferrite ( \% ) = 161 [ \frac{\begin{matrix}\% Cr + \% Mo + 1.5 \% Si + \\ 0.5 \% Nb + 2 \% Ti + 18\end{matrix}}{\begin{matrix}\% Ni + 30 \% C + 30 \% N + \\ 0.5 \% Mn + 36\end{matrix}} ] - 161 \qquad [ Equation ]$$

where δ-ferrite % represents % by volume, elements % represents % by weight.

The austenitic surface ferrite is evaluated and obtained by using the following equation.

₁₀ₘ=f[overall average-ferrite],(secondary cooling specific water volume),(heat flux),(casting velocity),(casting temperature) [Equation]

The ferritic equiaxed crystal ratio is evaluated and obtained by using the following equation.

Equiaxed crystal ratio_{(Ti=0.05)}=f[(average heat flux),(casting velocity),(casting temperature),(EMS-A)]

Equiaxed crystal ratio=f[(TiN crystallizing temperature),(average heat flux),(casting velocity),(casting temperature),(SiLAl),(Ti real yield)] [Equation]

The martensitic center segregation is evaluated and obtained by using the following equation.

Center segregation degree=f[(carbon steel %),(casting temperature),(casting velocity),(EMS current),(average heat flux),(secondary cooling specific water volume)] [Equation]

Further, the information measured in the oscillation mark quality is numerically evaluated in the evaluating step as oscillation mark depth, oscillation mark quality, carbon pick up (C-pick up) and sulfur pick up (S-pick up).

Here, the oscillation mark depth is evaluated and obtained by using the following equation.

Oscillation mark depth=f[mold frequency],[mold powder consumption amount]

Mold powder consumption amount=f[tundish molten steel temperature],(mold powder solidification temperature),(mold powder viscosity),(casting velocity),(mold frequency)] [Equation]

The oscillation mark quality is evaluated and obtained by using the following equation

Oscillation mark quality=f[casting velocity],(MLAC error rate),(SEN deposit depth),(oscillation mark depth)] [Equation]

The carbon pick up is evaluated and obtained by using the following equation

C_{pick up}=f[mold slag layer thickness],(Uᵥₐₗᵤₑ),(C % in mold powder)] [Equation]

The sulfur pick up is evaluated and obtained by using the following equation

S_{pick up}=f[mold slag layer thickness], (Uᵥₐₗᵤₑ),(S% in mold powder)] [Equation]

The mold slag layer thickness is calculated by a calculation model of mold powder melting velocity and consuming velocity.

Also, the information measured in the purity is numerically evaluated in the evaluating step as the amount of high melting point inclusion, inclusion Ti—Al-oxide content, reoxidation degree, Ti real yield, TiN crystallizing amount, TiN crystallizing temperature, nitrogen pore, Ar pore and oxide amount in steel.

The amount of high melting point inclusion is obtained by calculating and evaluating solid amount among nonmetal inclusions within molten steel as a tundish molten steel reference. The inclusion Ti—Al oxide content is obtained by calculating and evaluating TiO₂+Ti₂O₃+Al₂O₃ content having high correlation with surface quality among nonmetal inclusions within the molten steel as a tundish molten steel reference. The reoxidation degree is obtained by evaluating the reoxidation degree using the change of nitrogen concentration from AOD tapping to a tundish. The Ti real yield is obtained by calculating and evaluating Ti real yield for Ti adding steel (409L, 439, etc.). The TiN crystallizing amount is obtained by calculating and evaluating the TiN crystallizing amount of Ti adding steel (as a tundish reference) using thermodynamics. The TiN crystallizing temperature is obtained by thermodynamically calculating temperature forming TiN and evaluating the difference between it and the tundish temperature. The nitrogen pore is obtained by thermodynamically calculating and evaluating nitrogen gas formation amount during solidifying in case of high nitrogen steel. The Ar pore is obtained by evaluating it using Ar gas flow rate used during a continuous casting. The oxide amount in steel is obtained by thermodynamically calculating and evaluating a total of oxide content in molten steel as a tundish reference.

Also, the information measured in the continuous casting stability is numerically evaluated in the evaluating step as casting temperature deviation, casting temperature difference, casting velocity deviation, MLAC degree, sliding gate open size deviation, sliding gate open size change amount, molten steel flux, deposit depth of submerged nozzle, mold-slab friction force, slab surface temperature, and secondary cooling specific water volume.

The casting temperature deviation is obtained by calculating and evaluating the casting temperature deviation. The casting temperature difference is obtained by calculating and evaluating the difference between a set casting temperature and an actual casting temperature. The casting velocity deviation is obtained by calculating and evaluating the casting velocity deviation. The MLAC degree is obtained by calculating and evaluating meniscus fluctuation amount (±1 mm error rate). The sliding open size deviation is obtained by calculating and evaluating the sliding gate deviation. The sliding open size change amount is obtained by calculating and evaluating the change of the sliding gate open size between the initial and end of slab. The molten steel flux is molten steel flow velocity ascending upward after impacting on the short side of a mold, wherein the molten steel flow velocity ascending upward is obtained by calculating and evaluating a theoretical instant molten steel flow velocity exiting from an outlet, a distance from the meniscus to the molten steel impacting point on the short side of the copperplate, a distance from the center of the submerged nozzle to the molten steel impacting point on the short side of the copperplate, and a molten steel outlet angle at the outlet. The molten steel flux is obtained by calculating and evaluating the ascending molten steel flow velocity within the mold. The deposit depth of the submerged nozzle is obtained by calculating and evaluating the difference between the deposit depth of the submerged nozzle measured using a laser sensor and the deposit depth set under the operating standard. The mold-slab friction force is obtained by calculating and evaluating the mold-slab friction force using casting condition, mold powder consumption amount, etc. The slab surface temperature is obtained by calculating and evaluating the difference between the slab surface temperature measured using a thermometer and optimal value by steel. The secondary cooling specific water volume is obtained by calculating and evaluating the difference between the secondary cooling specific water volume calculated from the secondary cooling water flow rate data and the set value by steel.

Hereinafter, it will be described the preferred embodiments of an on-line quality prediction system for stainless steel slab according to the present invention with reference to the accompanying drawings.

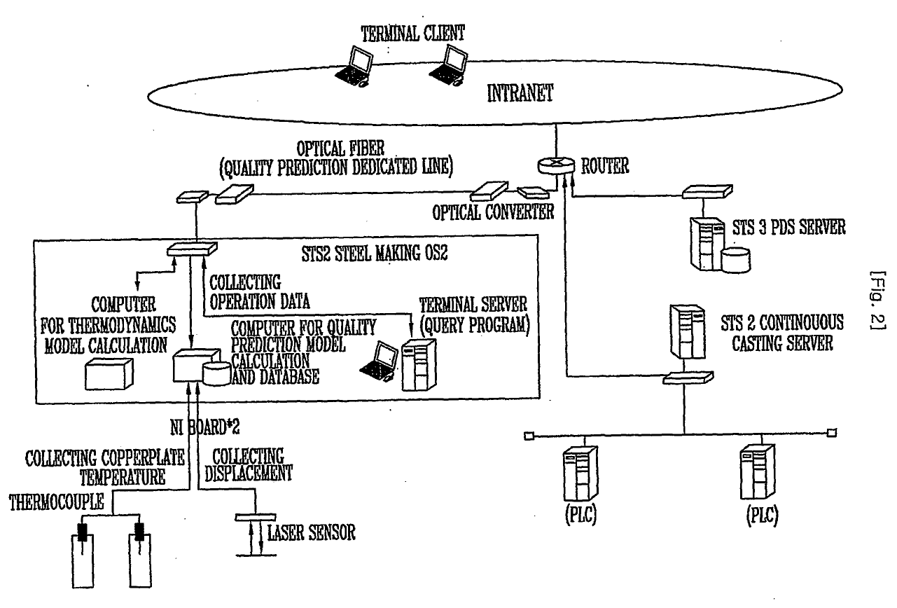

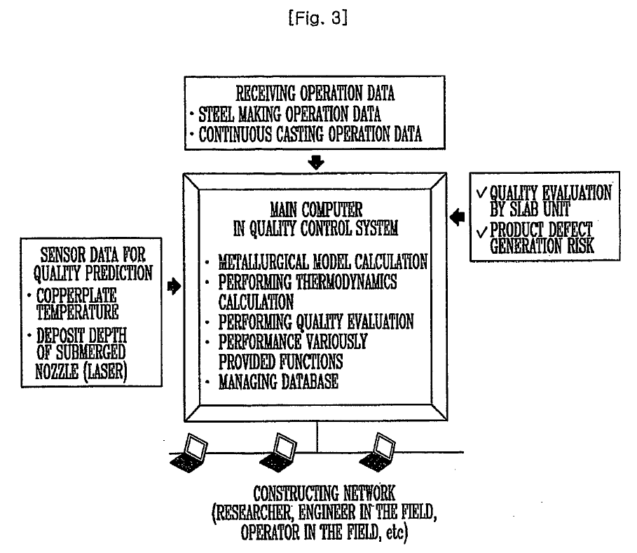

FIG. 2 is a view schematically showing an on-line quality prediction system for stainless steel slab according to a preferred embodiment of the present invention, and FIG. 3 is a conceptual view of FIG. 2.

An on-line quality prediction system for stainless steel slab according to the present invention comprises a main computer collecting and storing information from a production line for the stainless steel slab; a thermodynamics calculation only computer mutually communicating with the main computer; and a server computer mutually communicating with the main computer.

The main computer, the thermodynamics calculation only computer and the server computer are installed in a continuous casting cabin in a production line for stainless steel.

The thermodynamics calculation only computer can be configured to perform purity and solidification-related thermodynamics calculations. The solidification-related thermodynamics calculation uses Thermo-Calc. common used program and the purity-related calculation FactSage common used program.

Components, temperature and other data of steel required for the thermodynamics calculation are transferred to the main computer and then stored in a database. The transfer of data and calculation results into the database required for the calculation is made through mutual communication of the thermodynamics calculation only computer with the main computer.

The main computer performs core functions, such as data processing, metallurgical model calculation, and database management, etc. Operation data are collected via two paths: data, such as composition of steel, weight of molten steel, etc is collected from an integrated database, and data casting velocity, meniscus stability, tundish temperature, etc., measured in a constant time, for example, in five seconds interval is collected from other server, wherein all the data are transferred via a dedicated optical cable installed for an quality prediction system. The copperplate temperature that is a sensor for predicting quality and the deposit depth of a submerged nozzle measured using a laser are also transferred and processed to the main computer.

The terminal server computer is connected to a user connected to a network so that the user can query the result data of slab unit for which evaluation and prediction are completed.

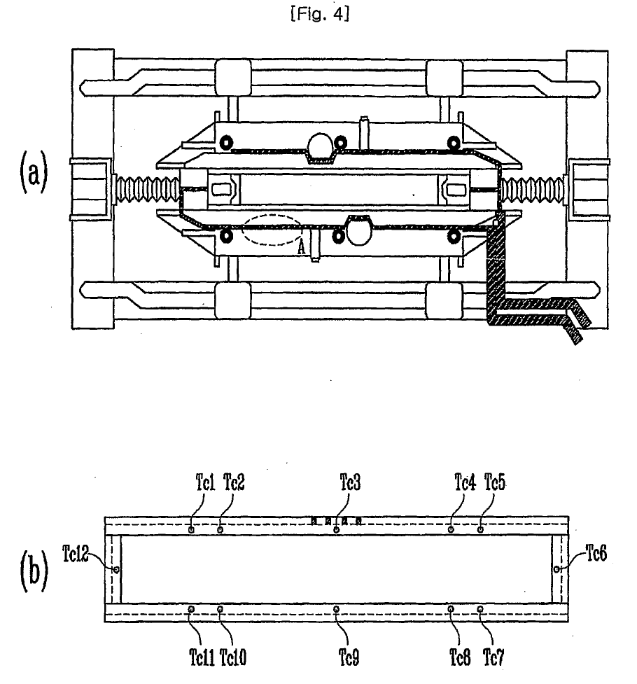

FIG. 4a is a view showing the insertion of a thermocouple into a mold for measuring initial solidification uniformity, and FIG. 4b is a view showing position of a thermocouple installed on a copperplate in FIG. 4a.

The initial solidification uniformity is a very important item in all kinds of steels, and is the optimal method for evaluating the possibility of crack generation that is a representative defect of slab.

In the preferred embodiments of the present invention, it has been evaluated the stability of heat transfer at initial solidification position by inserting the thermocouple into the copperplate for evaluating the initial solidification uniformity. In other words, it means that if temperature is stably maintained, heat transfer is stabilized such that the initial solidification is stably maintained.

The thermocouple inserted into the copperplate used a total of 12 K-type thermocouples. Five ones of the 12 K-type thermocouples are provided in the inside and outside of the long side of the rectangular copperplate, respectively, and one of them provided in the left and right of the short side thereof, respectively. The copperplate is inserted a vertical hole processed, and its upper part is rigidly fixed using a screw because of requiring durability in terms of quality prediction property.

Further, in order to assure the inner quality of the stainless steel upon casting it, in case of operating an electro-magnetic stirrer (EMS), if the thermocouple directly contacts with the copperplate, it may occur that temperature measurement is interfered by induced current generated from the electro-magnetic stirrer. As a result, the thermocouple is installed in a sheath type to generate floating potential on the copperplate. The thermocouple is positioned just under the meniscus on which the molten steel in the mold is positioned.

Further, the six thermocouples on the inner side and right of the copperplate are connected to one socket (not shown) and six thermocouples on the outside and left of the copperplate are connected to the other socket (not shown). As a result, the two sockets are extended out a mold so that the thermocouples are connected to the main computer, thereby transferring/inputting measuring numerical to the main computer via the thermocouples.

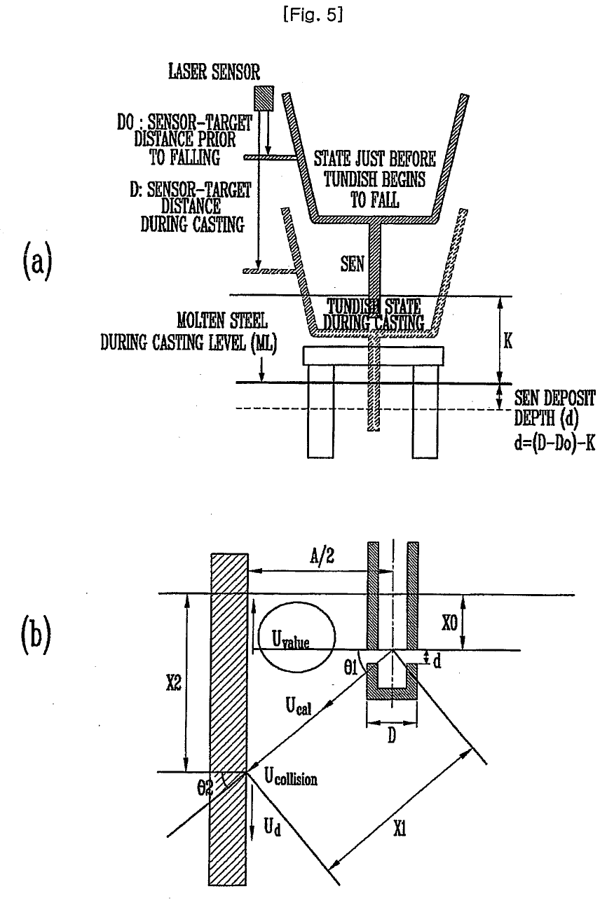

FIG. 5a is a view schematically showing a laser sensor for calculating deposit depth of a submerged nozzle among principles evaluating continuous casting operation stability and FIG. 5b is a view showing rise flow velocity for molten steel flux evaluation based on continuous casting operating stability evaluation principle.

The laser sensor is installed on the side of a tundish for measuring a distance. The side of the tundish is provided with a target being a measuring point of the laser sensor. The laser sensor measures a distance from itself to the target to transfer the data to the main computer.

The distance from the sensor to the target is set to D₀ before the tundish falls. The distance from the sensor to the target is set to D in the state that the tundish falls. The distance from the submerged nozzle to the molten steel level (ML) during casting is set to K and the deposit depth of the submerged nozzle d is set to (D-D₀) K before the tundish falls. The deposit depth of the submerged nozzle can be obtained in such a manner.

The molten steel flux (U-value) means the molten steel flow velocity ascending upward in the phenomenon that some molten steel flows exited from the outlet of the submerged nozzle in the mold ascend upward and other molten steel flows descend downward after impacting on the short side of the mold.

As the molten steel flux value is large, the intensity of ascending flow is large, resulting in that the molten steel meniscus is unstablized and incorporation defect of mold slag easily occurs.

Referring to FIG. 5b, the molten steel flux value is a theoretical instant molten steel flow velocity U_{cal} exiting from the outlet, a distance X2 from the meniscus to the molten steep impacting point on the short side of the copperplate X2, a distance X1 from the center of the submerged nozzle to the molten steel impacting point on the short side of the copperplate, and a molten steel outlet angle θ1 at the outlet.

Hereinafter, it will be described the preferred methods of a predicting method using an on-line quality prediction system for stainless steel slab according to the present invention.

A predicting method using an on-line quality prediction system for stainless steel slab according to the present invention comprises the steps of: measuring prediction items for predicting the stainless steel slab quality; evaluating for making numerical evaluation based on the measured prediction items; and predicting the stainless steel slab quality by analyzing the numerical yielded in the evaluating step.

Here, the prediction items are initial solidification uniformity, mold cooling velocity, slab solidification structure, slab oscillation mark quality, purity and continuous casting operation stability.

At this time, the information measured in the initial solidification uniformity is numerically evaluated in the evaluating step as copperplate temperature, copperplate temperature deviation, temperature ratio of the inside/outside of copperplate, temperature ratio of the left/right of copperplate, and temperature ratio of the long side/short side of copperplate.

The initial solidification uniformity is a very important item in all kinds of steels, and in particular, is the optimal method for evaluating the possibility of crack generation that is a representative defect of slab.

The evaluation on copperplate temperature among the information measured in the initial solidification uniformity is made by previously setting the required optimal value and then comparing it with the actually measured value. That is, the evaluation is made by calculating average copperplate temperature by slab unit and comparing the difference between it and optimal copperplate temperature by steel and then by the difference value between them. The larger the difference value of it and the preset optimal value is, the smaller score is yielded and the smaller the difference value is, the higher score is yielded.

The copperplate temperature deviation judges whether temperature distribution is uniform in the copperplate itself. That is, the initial solidification uniformity, that is, stability is evaluated by evaluating its deviation degree through statically analyzing the overall deviations of the copperplate temperature by slab unit. The smaller the deviation becomes, the higher the temperature distribution of the copperplate itself is, and the larger the deviation becomes, the lower the uniformity is.

The temperature ratio of the inside/outside of the copperplate is to evaluate the temperature difference of its inside/outside. The temperature of the inside/outside of the copperplate of the long side by slab unit is obtained as ratio so that the difference between the ratio and balance value, that is, 1 (the value that the copperplate temperature of the inside equals to that of the outside) is compared and evaluated. The smaller the deviation between the temperature ratio of the inside/outside of the copperplate and 1, the better its uniformity can be represented.

The temperature ratio of the left/right of the copperplate is to evaluate the temperature difference of its left/right. The temperature ratio of the left/right of the copperplate of short side by slab unit is yielded as ratio, and the difference between the ratio and balance value, that is, 1 (the value that the copperplate temperature of the left equals to that of the right) is compared and evaluated. The smaller the deviation between the temperature ratio of the left/right of the copperplate and 1, the better its property can be represented.

The temperature ratio of the long side/short side of the copperplate is to evaluate the temperature ratio of the long side/short side of the copperplate in a square shape. The temperature ratio of the long side and short side by slab unit is also yielded by comparing and evaluating the difference between the ratio and balance value, that is, 1 (the value that the copperplate temperature of the long side equals to that of the short side). The smaller the deviation between the temperature ratio of the long side/short side ratio of the copperplate and 1, the better its property can be represented.

Further, the information measured in the mold cooling velocity is numerically evaluated in the evaluating step as heat transfer amount, heat transfer amount deviation, heat transfer amount ratio of the inside/outside, heat transfer amount ratio of the left/right, and heat transfer amount ratio of the long/short sides.

The cooling velocity is a very important factor for solidification operation in a mold as average cooling velocity concept for the overall molds. That is, if the cooling velocity is lack, the thickness of the solidified shell of slab exiting from the mold is thinness so that slab swelling out phenomenon, that is, bulging phenomenon occurs and at the worst situation, slab blowing out phenomenon occurs. On the contrary, if heat transfer amount is excessive, it is easy to cause the slab blowing out phenomenon due to the excessive thermal stress. As a result, it is very important to keep proper heat transfer amount. The heat transfer amount in the present invention is calculated using the temperature rising of cooling water circulated in the mold and casting conditions. The calculation equation is as follows.

$$q = \frac{{ρ}_{w} {Cp}_{w} Δ {TF}_{w}}{{L}_{z} {L}_{w}} \qquad [ Equation ]$$

Here, q is heat transfer amount from strand face and its unit is J/m²sec=W/m², L and L_{w}, respectively, is strand length and width in the mole and its unit is m_{w}, is density of cooling water and its unit is kg/m³, C_{PW} is specific heat of cooling water and its unit is J/kg° C., ΔT is the difference between the output side temperature and the input side temperature as temperature rising width of mold cooling water and its unit is ° C., and F_{W} is flow rate of cooling water and its unit is m³/sec.

All data required for calculation are collected from the continuous casting operation data and the heat transfer amount is calculated by obtaining data average value corresponding to the slab in question.

The heat transfer amount is obtained by calculating average heat transfer amount by slab unit and evaluating the difference between it and the optimal heat transfer amount by steel, wherein it is evaluated depending on the difference between it and the required optimal value.

The heat transfer amount deviation is obtained by evaluating deviation degree through the statistical analysis of all the heat transfer amount deviations by slab unit, wherein the smaller the deviation, the better its property is represented.

The heat transfer amount ratio of the inside/outside is obtained by evaluating the balance degree of the heat transfer amount by calculating the heat transfer amount ratio of the inside and outside of the copperplate of the long side by slab unit and evaluating the difference between it and balance value, that is, the value that the heat transfer amount ratio of the inside/outside is 1.

The heat transfer amount ratio of the left/right is obtained by evaluating the balance degree of the heat transfer amount by calculating the heat transfer amount ratio of the left and right of the copperplate of the short side by slab unit and evaluating the difference between it and balance value, that is, the value that the heat transfer amount ratio of the left/right is 1.

The heat transfer amount ratio of the long side/short side is obtained by evaluating the balance degree of the heat transfer amount by calculating the heat transfer amount ratio of the long side and the short side by slab unit and evaluating the difference between it and balance value, that is, the value that the heat transfer amount ratio of the long side/short side is 1.

The heat transfer amount ratio of the inside/outside, the heat transfer amount ratio of the left/right, and the heat transfer amount ratio of the long side/short side are 1 as the most ideal numerical, wherein as the ratios are further away 1, their property gets worse.

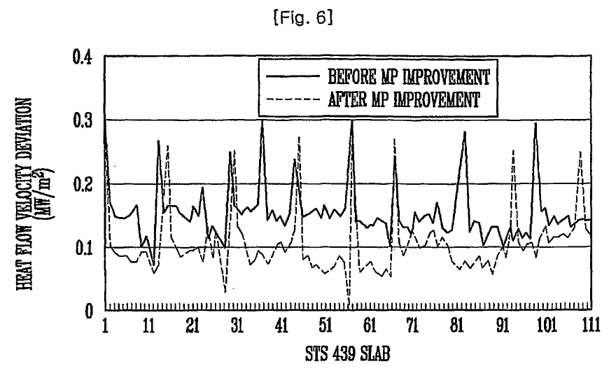

FIG. 6 is a graph showing an effect utilizing mold heat transfer evaluation item of a predicting method using an on-line quality prediction system for stainless steel slab according to a preferred embodiment of the present invention.

As shown in FIG. 6, in process of developing a steel kind of mold power containing a large amount of Ti, when applying the preferred embodiments of the present invention, it will be appreciated that the heat transfer deviation of the mold powder is small over that of the prior art so that uniform heat transfer can be induced, thereby predicting the improvement of quality.

Further, the information measured in the slab solidification structure is numerically evaluated in the evaluating step as austenitic average residual ferrite, austenitic surface ferrite, ferritic equiaxed crystal ratio, and martensitic center segregation degree.

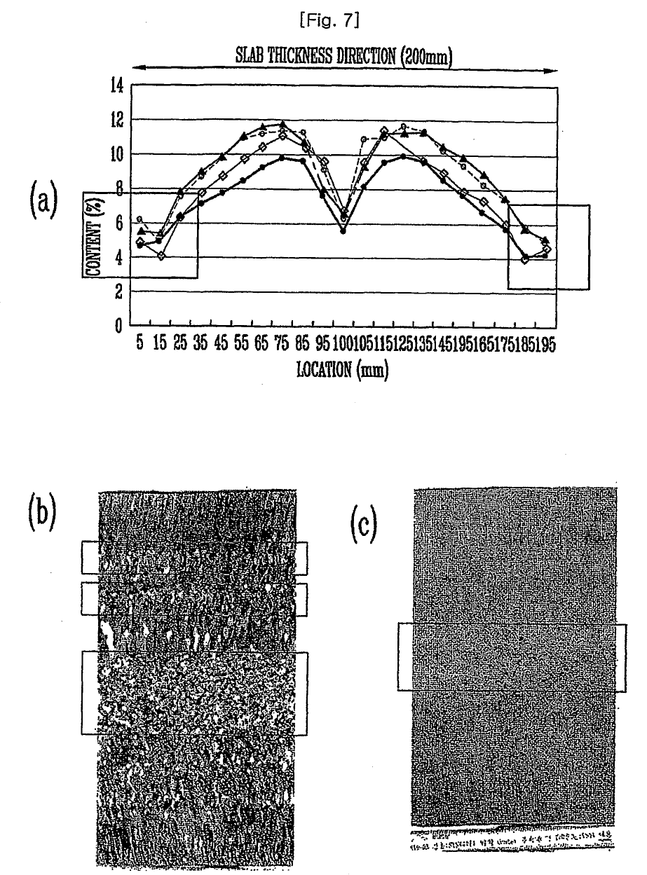

FIG. 7a is a graph showing distribution of delta ferrite in 304 steel slab, FIG. 7b is a photograph of macro solidification structure showing 430 steel slab solidification structure, and FIG. 7c is a photograph of macro solidification structure showing 420 steel slab solidification structure.

The slab solidification structures are divided into solidification structure directly connected with quality by steel. In other words, 300 series steel, that is, austenitic steel evaluates residual delta ferrite of slab.

Referring to FIG. 7a, there is very close correlation between slab thickness-directional delta ferrite and product quality. The distribution value of optimal delta ferrite can be obtained in experience. Therefore, the embodiments of the present invention use operation results to predict the distribution of the delta ferrite by slab thickness, thereby evaluating its soundness.

Referring to FIG. 7b, the ferritic stainless steel evaluates equiaxed crystal ratio inside of slab. The equiaxed crystal ratio means a portion having fine solidification structure as shown in a tetragonal edge of FIG. 7b. If the equiaxed crystal ratio is assured, ridging defect in a final product can not be caused as well as annealing operation can be omitted.

The embodiments of the present invention develop the metallurgical model for predicting the equiaxed crystal ratio to predict the equiaxed crystal ratio from the operation result.

Referring to FIG. 7, since martensitic stainless steel contains a large amount of carbon, carbon segregation of slab center part as shown in a tetragonal edge of FIG. 7c becomes the most important. The embodiments of the present invention develop a metallurgical model for predicting the carbon segregation of slab center part to predict slab quality.

The evaluation result as described above can be used for predicting M-sliver in austenitic steel, judging thermal mist annealing in ferritic steel, and predicting lamination defect in martensitic steel.

Here, the austenitic average residual ferrite is evaluated and obtained by using the following equation called KRUPP Equation.

The smaller the difference between the obtained value and the optimal value, the better its property can be predicted.

The austenitic surface ferrite is evaluated and obtained by using the following equation.

₁₀ₘ=f[overall average-ferrite],(secondary cooling specific water volume),(heat flux),(casting velocity),(casting temperature) [Equation]

Likewise, the smaller the difference between the obtained value and the optimal value, the better its property can be predicted.

The ferritic equiaxed crystal ratio is evaluated and obtained by using the following equation.

Equiaxed crystal ratio_{(Ti=0.05)=}f[(average heat flux),(casting velocity),(casting temperature),(EMS-A)]

Equiaxed crystal ratio_{(Ti>0.05)}=f[(TiN crystallizing temperature),(average heat flux),(casting velocity),(casting temperature),(SilAl),(Ti real yield)] [Equation]

Even if Ti is 0.05 or less or 0.05 or more, the higher the equiaxed crystal ratio, the better its property can be represented.

The martensitic center segregation is evaluated and obtained by using the following equation.

Center segregation degree=f[(carbon steel %),(casting temperature),(casting velocity),(EMS current),(average heat flux),(secondary cooling specific water volume)] [Equation]

At this time, the more the center segregation approaches 1, the better its property can be represented.

An item that is independent variable in the model can directly be used as the primary operation data, and an item secondarily processed or evaluated in secondary model equation can be used.

Further, the information measured in the oscillation mark quality is numerically evaluated in the evaluating step as oscillation mark depth, oscillation mark quality, carbon pick up (C-pick up) and sulfur pick up (S-pick up).

The oscillation mark is a mark with a depth existing in a constant interval formed on the slab surface by reciprocating the mold top and bottom with a constant amplitude and frequency in order to continuously cast it. Since the stainless steel has a very small amount of scale removed in a continuous casting and a heating furnace, in particular the oscillation mark quality is important. That is, if the depth the oscillation mark is excessive or the oscillation mark has segregation and crack, these slab defects are directly connected with the final product defects.

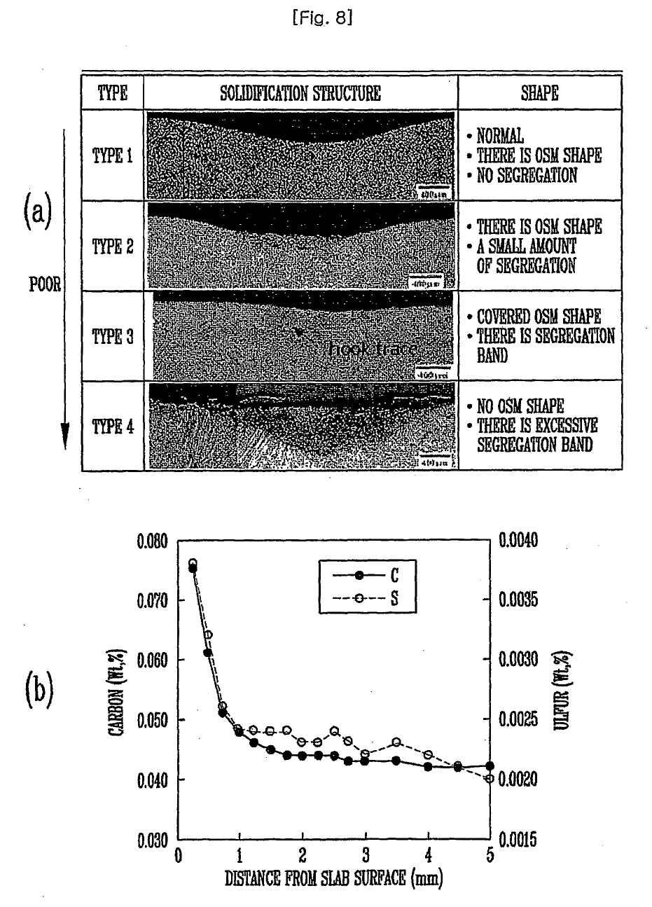

FIG. 8a is a view sorting oscillation mark quality, and FIG. 8b is a graph showing carbon and sulfur picked up from mold powder on a slab surface including oscillation mark.

Referring to FIG. 8a, it shows that as the type of the oscillation mark is increased, the quality is degraded.

Referring to FIG. 8b, it shows that the pick up of carbon and sulfur is also as important as the oscillation mark quality. The embodiments of the present invention develop the metallurgical model for using operation result and mold powder property to predict the depth and quality of the oscillation mark, and the carbon and sulfur pick up amount in the slab surface as described above, thereby evaluating the slab quality.

The oscillation mark depth is evaluated and obtained by using the following equation.

Oscillation mark depth=f[mold frequency],[mold powder consumption amount]

Mold powder consumption amount=f[tundish molten steel temperature],(mold powder solidification temperature),(mold powder viscosity),(casting velocity),(mold frequency)] [Equation]

At this time, the smaller the oscillation mark depth, the better its property is evaluated.

Oscillation mark quality=f[casting velocity],(MLAC error rate),(SEN deposit depth),(oscillation mark depth)] [Equation]

The higher the oscillation mark quality value, the better its property is evaluated.

The carbon pick up is evaluated and obtained by using the following equation

C_{pick up}=f[mold slag layer thickness],(Uᵥₐₗᵤₑ),(C% in mold powder)] [Equation]

The sulfur pick up is evaluated and obtained by using the following equation

S_{pick up}=f[mold slag layer thickness],(Uᵥₐₗᵤₑ),(S% in mold powder)] [Equation]

In either case of carbon or sulfur pick up, the smaller the numerical, the better their properties are. The mold slag layer thickness is calculated by the calculation models for mold powder melting velocity and consumption velocity.

The method is mainly used for the prediction of 300 series M-sliver defect and black band defect caused due to the carburizing.

An item that is independent variable in the model can directly be used as the primary operation data, and an item secondarily processed or evaluated in secondary model equation can be used.

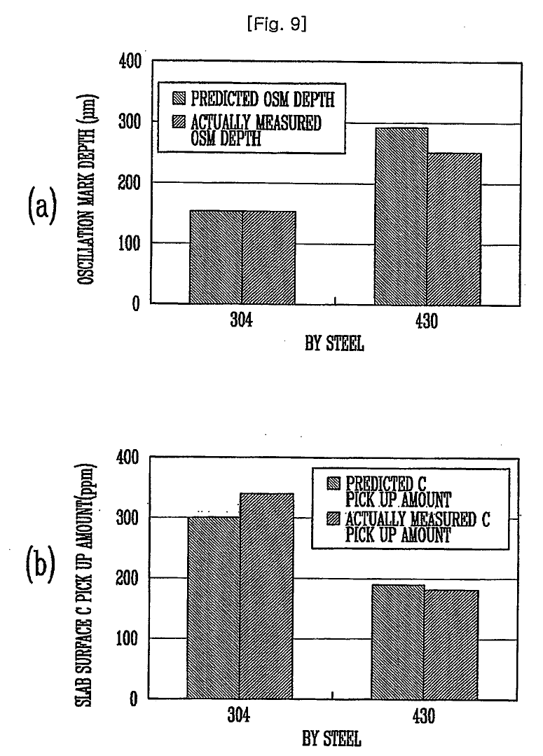

FIG. 9a is a graph showing the difference between a prediction value and an actual value of oscillation mark and FIG. 9b is a graph showing the difference between a prediction value and an actual value of carbon pick-up amount.

Referring to FIG. 9a, in the prediction of the 300 series steel such as 304 steel, it shows that the prediction value approximately conforms to the actual value. Meanwhile, in the prediction of the 400 series steel such as 430 steel, the prediction value is larger than the actual value, however, it may be appreciated that the prediction value approaches the actual value to some extent. Therefore, in the 400 series steel, when developing a technology not grinding the slab, it may be appreciated that it is necessary to the decrease of the oscillation mark depth.

Referring to FIG. 9b, it may be appreciated that the carbon pick up amount in the predicted slab surface approximately approaches the actual pick up amount. Such the data can be used in the development of mold powder with low carbon or low sulfur.

The information measured in the purity is numerically evaluated in the evaluating step as the amount of high melting point inclusion, inclusion Ti—Al-oxide content, reoxidation degree, Ti real yield, TiN crystallizing amount, TiN crystallizing temperature, nitrogen pore, Ar pore and oxide amount in steel.

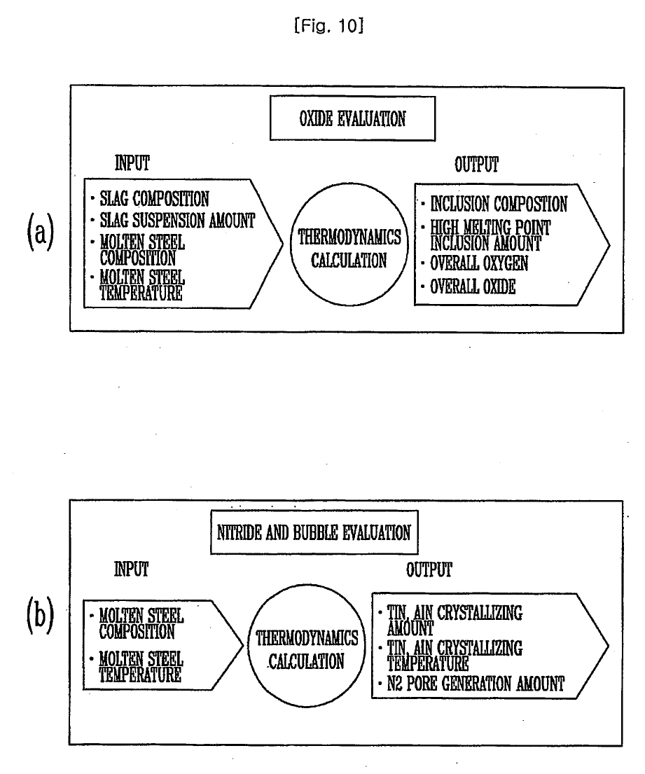

FIG. 10a is a view graphically showing concept of oxide evaluation according to an embodiment of the present invention and FIG. 10b is a view graphically showing concept of nitride and bubble evaluation according to an embodiment of the present invention.

In oxide evaluation shown in FIG. 10a, FactSage common used program is used for thermodynamics calculation. In nitride and bubble evaluation, ThermoCalc common used program is used for thermodynamics calculation. The prediction of inclusion operation. The operation data such as composition and temperature, etc., required for the calculation uses the values stored in the database.

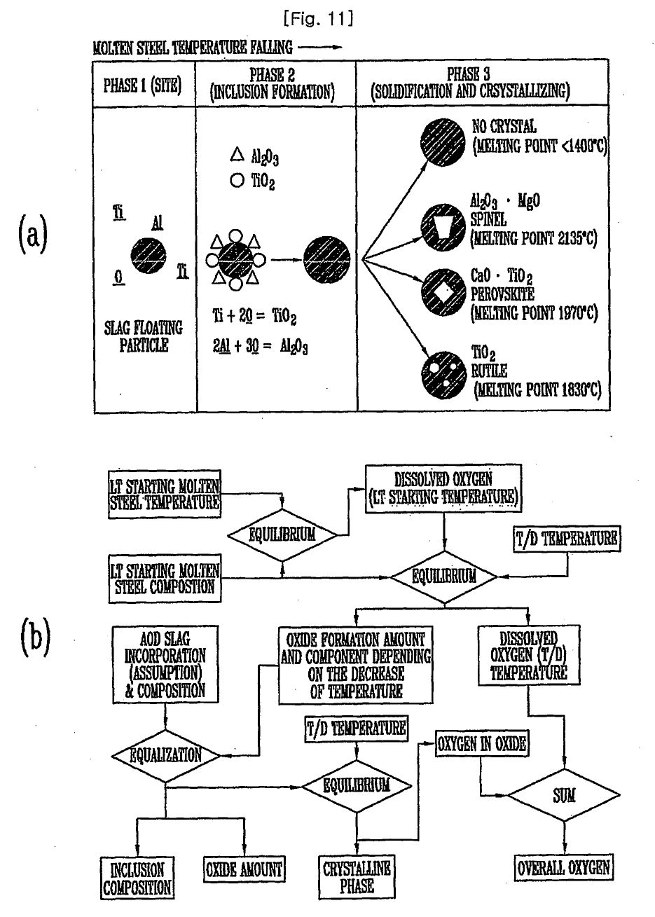

FIG. 11a is a view graphically showing an internal inclusions forming device and FIG. 11b is a view graphically showing a method of calculating composition, oxide amount, crystalline phase, overall oxygen of internal inclusions based on the forming device shown in FIG. 11a.

The composition, amount, overall oxygen, overall oxide amount of the inclusions inside of the nonmetal are the most important items in the purity evaluation.

Referring to FIG. 11a, it may be appreciated that the composition and amount of the inclusion are changed by the deoxidation reaction of Al, Ti, etc., in the molten steel depending on the decrease of temperature using slag particles suspended in the molten steel as nucleating site.

Referring to FIG. 11b, the composition, oxide amount, crystalline phase, overall oxygen and the like of the inclusion can be calculated using FactSage common used program based on the forming device.

The amount of high melting point inclusion is obtained by calculating and evaluating solid amount among nonmetal inclusions within molten steel as a tundish molten steel reference. The more the solid amount, the worse its property can be predicted.

The inclusion Ti—Al oxide content is obtained by calculating and evaluating TiO₂+Ti₂O₃+Al₂O₃ content having high correlation with surface quality among nonmetal inclusions within the molten steel as a tundish molten steel reference. The more the inclusion Ti—Al oxide content, the worse its property is predicted.

The reoxidation degree is obtained by evaluating the reoxidation degree using the change of nitrogen concentration from AOD tapping to a tundish.

The Ti real yield is obtained by calculating and evaluating Ti real yield for Ti adding steel (409L, 439, etc.). The higher the value, the better its property is evaluated.

The TiN crystallizing amount is obtained by calculating and evaluating the TiN crystallizing amount of Ti adding steel (as a tundish reference) using thermodynamics. The more the TiN crystallizing amount, the worse its property becomes.

The TiN crystallizing temperature is obtained by thermodynamically calculating temperature forming TiN and evaluating the difference between it and the tundish temperature. As the TiN crystallizing temperature is high comparing with the tundish molten steel temperature, that is, the higher the TiN crystallizing temperature, the worse its property is predicted.

The nitrogen pore is obtained by thermodynamically calculating and evaluating nitrogen gas formation amount during solidifying in case of high nitrogen steel. The Ar pore is obtained by evaluating it using Ar gas flow rate used during a continuous casting. The oxide amount in steel is obtained by thermodynamically calculating and evaluating a total of oxide content in molten steel as a tundish reference. The higher both of the nitrogen pore and the Ar pore, the worse its property becomes.

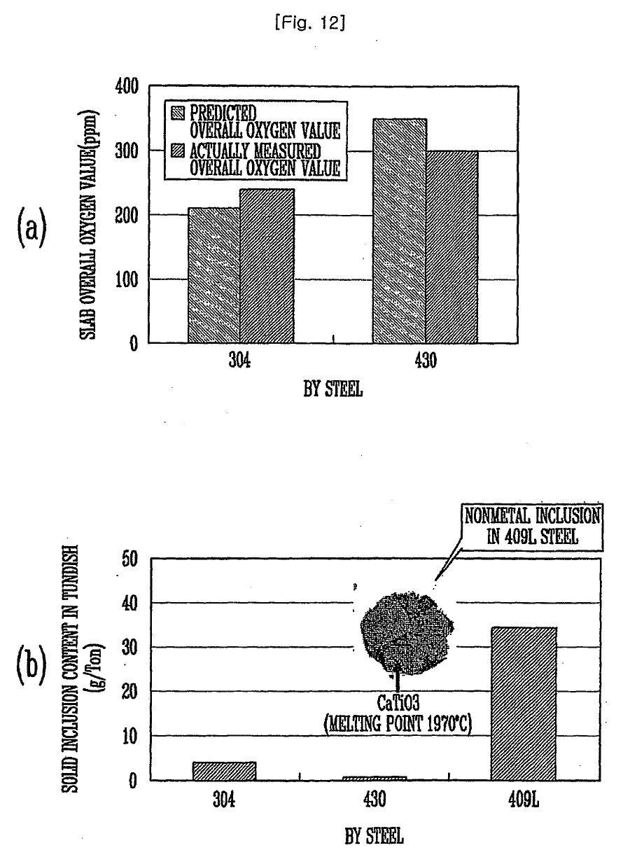

FIG. 12a is a view showing mutual comparison between a prediction value of overall oxygen with an actual value of overall oxygen and FIG. 12b is a graph showing prediction value of the amount of high melting point inclusion among inclusions in steel.

Referring to FIG. 12a, it may be appreciated that a predicted overall oxygen value is similar to an actual overall oxygen value.

Referring to FIG. 12b, it may be appreciated that very good inclusions without high melting point in 304 steel and 403 steel is predicted and significant amount inclusions having high melting point in 409L steel is predicted. In actual, it has been confined that there is high melting point phase such as CaTiO₃ in 409L steel.

The information measured in the continuous casting stability is numerically evaluated in the evaluating step as casting temperature deviation, casting temperature difference, casting velocity deviation, MLAC degree, sliding gate open size deviation, sliding gate open size change amount, molten steel flux, deposit depth of submerged nozzle, mold-slab friction force, slab surface temperature, and secondary cooling specific water volume. The continuous casting stability evaluates the difference between the target value and the result value, which is important continuous casting operation factor associated with quality.

More specifically, the casting velocity deviation, casting temperature deviation, MLAC degree, and mold-slab friction force are factors essentially evaluated in the continuous casting operation; the deposit depth of submerged nozzle, the rising flow velocity, the sliding gate open size deviation, and the sliding gate open size change amount are evaluation factors associated with the control of the molten steel flux in the mold; and the secondary cooling specific water volume and the slab surface temperature are evaluation factors associated with secondary cooling.

The casting temperature deviation is obtained by calculating and evaluating the casting temperature deviation. The casting temperature difference is obtained by calculating and evaluating the difference between a set casting temperature and an actual casting temperature. The casting velocity deviation is obtained by calculating and evaluating the casting velocity deviation. The smaller all the casting temperature deviation, the casting temperature difference, and the casting velocity deviation, the better the evaluation result is yielded.

The MLAC degree is obtained by calculating and evaluating meniscus fluctuation amount (±1 mm error rate). The sliding open size change amount is obtained by calculating and evaluating the change of the sliding gate open size between the initial and end of slab. The sliding open size deviation is obtained by calculating and evaluating the sliding gate deviation. The higher the evaluation on MLAC degree, and the smaller the sliding gate open size deviation and the sliding gate open size change amount, the better the evaluation result becomes.

The molten steel flux (U-value) is obtained by calculating and evaluating the molten steel flow velocity within the mold. The smaller the value, the better the evaluation result becomes.

The deposit depth of the submerged nozzle is obtained by calculating and evaluating the difference between the deposit depth of the submerged nozzle measured using a laser sensor and the deposit depth set under the operating standard. The smaller the difference, the better the evaluation result becomes.

The mold-slab friction force is obtained by calculating and evaluating the mold-slab friction force using casting condition, mold powder consumption amount, etc. As the friction force is small, it is possible to make a stabilized operation and produce an excellent product.

The slab surface temperature is obtained by calculating and evaluating the difference between the slab surface temperature measured using a thermometer and optimal value by steel. The secondary cooling specific water volume is obtained by calculating and evaluating the difference between the secondary cooling specific water volume calculated from the secondary cooling water flow rate data and the set value by steel.

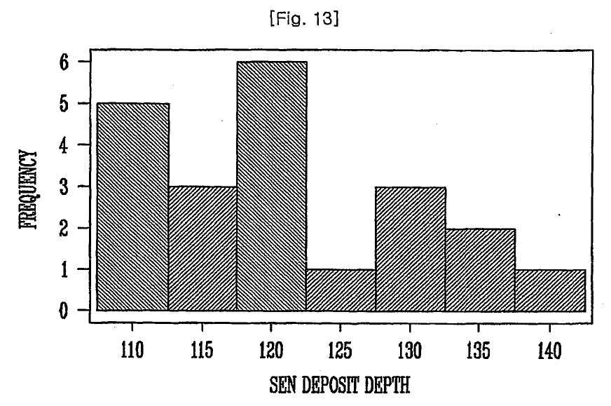

FIG. 13 is a graph showing an effect utilizing deposit depth evaluating item of a submerged nozzle of a predicting method using an on-line quality prediction system for stainless steel slab according to a preferred embodiment of the present invention.

Referring to FIG. 13, when applying the laser sensor according to the preferred embodiments of the present invention, it may be appreciated that the deposit depths applied in the current operation exactly conform to 110 mm and 120 mm. Meanwhile, it may be appreciated that the distribution of the conventional deposit depths is from 100 to 140 mm.

As a result, the enhancement of final product quality can be expected by exactly observing the required deposit depths.

The items numerically represented through the evaluation as above are collected into the system so that they are used for quality evaluation by slab unit, product defect generating probability evaluation by slab unit, quality analysis, and operation guide by quality problem, etc.

Although a few embodiments of the present invention have been shown and described, it would be appreciated by those skilled in the art that changes might be made in this embodiment without departing from the principles and spirit of the invention, the scope of which is defined in the claims and their equivalents.

1. An on-line quality prediction system for stainless steel slab comprising:
a main computer collecting and storing information from a production line for the stainless steel slab;
a thermodynamics calculation only computer mutually communicating with the main computer; and
a server computer mutually communicating with the main computer;

2. The on-line quality prediction system for stainless steel slab as claimed in claim 1, wherein a plurality of thermocouples are inserted into a copperplate in a sheath type to provide temperature information about initial solidification uniformity to the main computer, five ones of the plurality of thermocouples being provided in the inside and outside of the long side of the copperplate, respectively, and one of them provided in the left and right of the short side thereof, respectively.

3. The on-line quality prediction system for stainless steel slab as claimed in claim 1, wherein further comprises a laser distance sensor connected to the main computer to provide information about deposit depth of a submerged nozzle to the main computer.

4. A predicting method using an on-line quality prediction system for stainless steel slab, comprising the steps of:
measuring prediction items for predicting the stainless steel slab quality;
evaluating for making numerical evaluation based on the measured prediction items; and
predicting the stainless steel slab quality by analyzing the numerical yielded in the evaluating step.

5. The predicting method using an on-line quality prediction system for stainless steel slab as claimed in claim 4, wherein the prediction items are initial solidification uniformity, mold cooling velocity, slab solidification structure, slab oscillation mark quality, purity and continuous casting operation stability.

6. The predicting method using an on-line quality prediction system for stainless steel slab as claimed in claim 5, wherein the information measured in the initial solidification uniformity is numerically evaluated in the evaluating step as copperplate temperature, copperplate temperature deviation, temperature ratio of the inside/outside of copperplate, temperature ratio of the left/right of copperplate, and temperature ratio of the long side/short side of copperplate.

7. The predicting method using an on-line quality prediction system for stainless steel slab as claimed in claim 5, wherein the information measured in the mold cooling velocity is numerically evaluated in the evaluating step as heat transfer amount, heat transfer amount deviation, heat transfer amount ratio of the inside/outside, heat transfer amount ratio of the left/right, and heat transfer amount ratio of the long/short sides.

8. The predicting method using an on-line quality prediction system for stainless steel slab as claimed in claim 5, wherein the information measured in the slab solidification structure is numerically evaluated in the evaluating step as austenitic average residual ferrite, austenitic surface ferrite, ferritic equiaxed crystal ratio, and martensitic center segregation degree.

9. The predicting method using an on-line quality prediction system for stainless steel slab as claimed in claim 8, wherein the austenitic average residual ferrite is evaluated and obtained by using the following KRUPP equation;
$$\begin{matrix}δ \text{-} ferrite ( \% ) = 161 [ \frac{\% Cr + \% Mo + 1.5 \% Si + 0.5 \% Nb + 2 \% Ti + 18}{\begin{matrix}\% Ni + 30 \% C + \\ 30 \% N + 0.5 \% Mn + 36\end{matrix}} ] - 161 & \end{matrix} \qquad [ KRUPP equation ]$$
where δ-ferrite % represents % by volume, elements % represents % by weight, the austenitic surface ferrite is evaluated and obtained by using the following equation;
₁₀ₘ=f[overall average-ferrite],(secondary cooling specific water volume),(heat flux),(casting velocity),(casting temperature). [Equation]

10. The predicting method using an on-line quality prediction system for stainless steel slab as claimed in claim 8, wherein the ferritic equiaxed crystal ratio is evaluated and obtained by using the following equation;
Equiaxed crystal ratio_{(Ti=0.05)}=f[(average heat flux),(casting velocity),(casting temperature),(EMS-A)]
Equiaxed crystal ratio_{(Ti>0.05)}=f[(TiN crystallizing temperature),(average heat flux),(casting velocity),(casting temperature),(SilAl),(Ti real yield)]. [Equation]

11. The predicting method using an on-line quality prediction system for stainless steel slab as claimed in claim 8, wherein the martensitic center segregation is evaluated and obtained by using the following equation;
Center segregation degree=f[(carbon steel %),(casting temperature),(casting velocity),(EMS current),(average heat flux),(secondary cooling specific water volume)]. [Equation]

12. The predicting method using an on-line quality prediction system for stainless steel slab as claimed in claim 5, wherein the information measured in the oscillation mark quality is numerically evaluated in the evaluating step as oscillation mark depth, oscillation mark quality, carbon pick up (C-pick up) and sulfur pick up (S-pick up).

13. The predicting method using an on-line quality prediction system for stainless steel slab as claimed in claim 12, wherein the oscillation mark depth is evaluated and obtained by using the following equation;
Oscillation mark depth=f[mold frequency],[mold powder consumption amount]
Mold powder consumption amount=f[tundish molten steel temperature],(mold powder solidification temperature),(mold powder viscosity),(casting velocity),(mold frequency)] [Equation]
the oscillation mark quality is evaluated and obtained by using the following equation;
Oscillation mark quality=f[casting velocity],(MLAC error rate),(SEN deposit depth),(oscillation mark depth)]. [Equation]

14. The predicting method using an on-line quality prediction system for stainless steel slab as claimed in claim 12, wherein the carbon pick up is evaluated and obtained by using the following equation;
C_{pick up}=f[mold slag layer thickness],(Uᵥₐₗᵤₑ),(C% in mold powder)] [Equation]
the sulfur pick up is evaluated and obtained by using the following equation;
S_{pick up}=f[mold slag layer thickness],(Uᵥₐₗᵤₑ),(S % in mold powder)] [Equation]

15. The predicting method using an on-line quality prediction system for stainless steel slab as claimed in claim 5, wherein the information measured in the purity is numerically evaluated in the evaluating step as the amount of high melting point inclusion, inclusion Ti—Al-oxide content, reoxidation degree, Ti real yield, TiN crystallizing amount, TiN crystallizing temperature, nitrogen pore, Ar pore and oxide amount in steel.

16. The predicting method using an on-line quality prediction system for stainless steel slab as claimed in claim 15, wherein the amount of high melting point inclusion is obtained by calculating and evaluating solid amount among nonmetal inclusions within molten steel as a tundish molten steel reference.

17. The predicting method using an on-line quality prediction system for stainless steel slab as claimed in claim 15, wherein the inclusion Ti—Al oxide content is obtained by calculating and evaluating TiO₂+Ti₂O₃+Al₂O₃ content having high correlation with surface quality among nonmetal inclusions within the molten steel as a tundish molten steel reference.

18. The predicting method using an on-line quality prediction system for stainless steel slab as claimed in claim 15, wherein the reoxidation degree is obtained by evaluating the reoxidation degree using the change of nitrogen concentration from AOD tapping to a tundish.

19. The predicting method using an on-line quality prediction system for stainless steel slab as claimed in claim 15, wherein the Ti real yield is obtained by calculating and evaluating Ti real yield for Ti adding steel (409L, 439, etc.).

20. The predicting method using an on-line quality prediction system for stainless steel slab as claimed in claim 15, wherein the TiN crystallizing amount is obtained by calculating and evaluating the TiN crystallizing amount of Ti adding steel (as a tundish reference) using thermodynamics;
the TiN crystallizing temperature is obtained by thermodynamically calculating temperature forming TiN and evaluating the difference between it and the tundish temperature.

21. The predicting method using an on-line quality prediction system for stainless steel slab as claimed in claim 15, wherein the nitrogen pore is obtained by thermodynamically calculating and evaluating nitrogen gas formation amount during solidifying in case of high nitrogen steel;
the Ar pore is obtained by evaluating it using Ar gas flow rate used during a continuous casting.

22. The predicting method using an on-line quality prediction system for stainless steel slab as claimed in claim 15, wherein the oxide amount in steel is obtained by thermodynamically calculating and evaluating a total of oxide content in molten steel as a tundish reference.

23. The predicting method using an on-line quality prediction system for stainless steel slab as claimed in claim 5, wherein the information measured in the continuous casting stability is numerically evaluated in the evaluating step as casting temperature deviation, casting temperature difference, casting velocity deviation, MLAC degree, sliding gate open size deviation, sliding gate open size change amount, molten steel flux, deposit depth of submerged nozzle, mold-slab friction force, slab surface temperature, and secondary cooling specific water volume.

24. The predicting method using an on-line quality prediction system for stainless steel slab as claimed in claim 23, wherein the deposit depth of the submerged nozzle is obtained by calculating and evaluating the difference between the deposit depth of the submerged nozzle measured using a laser sensor and the deposit depth set under the operating standard.
